(19) United States
(12) Patent Application Publication
(10) Pub. No.: US 2006/0140117 A1
(43) Pub. Date: Jun. 29, 2006

(54) Apparatus and method for cell selection

(76) Inventors: Naveen Aerrabotu, Gurnee, IL (US); David J. Krause, Hainesville, IL (US); Varalakshmi Likiki, Gurnee, IL (US)

Correspondence Address: MOTOROLA INC, 600 NORTH US HIGHWAY 45, ROOM AS437, LIBERTYVILLE, IL, 60048-5343, US

(21) Appl. No.: 11/025,157

(22) Filed: Dec. 29, 2004

(51) Int. Cl. H04L 12/26

(52) U.S. Cl. 370/232; 370/253

(57) ABSTRACT

A method and apparatus for cell selection. A wireless communication device (110) can operate on a first cell (120). An expected data rate of a second cell (130) can be determined. The wireless communication device (110) can switch from the first cell (120) to the second cell (130) based on the expected data rate. The wireless communication device (110) may generate a prioritized active list of neighbor cells (130, 140, 150, 160) based on a signal strength measurement and data rate information.

### BACKGROUND

1. Field

The present disclosure is directed to a method and apparatus for cell selection. More particularly, the present disclosure is directed to selection of a cell for switching from a first cell to the selected cell based on cell measurements.

2. Description of Related Art

Presently, a wireless communication device can operate on a cell among a plurality of cells and can switch between cells. To switch between cells, the wireless communication device can generate an active list that indicates potential handoff cells. Present handoff and cell switching procedures are tied to signal strength measurements. For example, handoff in a code division multiple access (CDMA) system or a global system for mobile communication (GSM) system primarily depends on radio sub-system criteria such as radiofrequency levels and signal quality and network directed information such as current traffic load per cell and maintenance requests. A network can provide a list of neighbor cells to a wireless communication device and the wireless communication device takes the radio measurements from the cells. These measurements are reported to the serving cell on a regular basis. For example, pilot strength measurements are used to generate a candidate list and are sent to the network to perform handoff as needed. When the network determines a need for a handoff, the network will send a handoff command to the wireless communication device. As a further example, in wideband code division multiple access (WCDMA) or code division multiple access-1X (CDMA-1X), the wireless communication device sends a list of qualified active and candidate pilots to the network. The network uses this list to perform the handoff by sending a handoff command to the wireless communication device on the new cell. Upon receipt of a handoff command, the wireless communication device will release the link layer connections with the old base station of the current cell, disconnect the physical channels, switch to the new assigned channel, and initiate the establishment of lower layer connections. Unfortunately, because current handoff procedures are based on signal strength measurements, they do not guarantee a wireless communication device an expected data rate on an intended target cell.

Also, cellular topography is changing where multiple technological solutions may be overlaid in the same geographical region. Unfortunately, in a cell topography of multiple or single technologies with different characteristics, the primary measure of signal strength at the wireless communication device may not be a sufficient statistic to generate an accurate active list and make a first level decision to trigger a handoff. For example, a wireless communication device does not know the current data performance of a potential destination cell when it is performing measurements and sending an active list to a cell on a network.

Thus, there is a need for an enhanced handoff or system selection procedure in systems such as CDMA-1X, GSM, or other systems that can exploit this network topography and give better performance to the end user. There is also a need to optimize the admission control procedures by developing intelligence in the mobile to get to a cell with better performance. These and other needs can be fulfilled by the present disclosure.

### SUMMARY

A method and apparatus for cell selection. A wireless communication device can operate on a first cell. An expected data rate of a second cell can be determined. The wireless communication device can switch from the first cell to the second cell based on the expected data rate. The wireless communication device may generate a prioritized active list of neighbor cells based on a signal strength measurement and data rate information.

### BRIEF DESCRIPTION OF THE DRAWINGS

The embodiments of the present disclosure will be described with reference to the following figures, wherein like numerals designate like elements, and wherein:

FIG. 1 is an exemplary block diagram of a system according to one embodiment;

FIG. 2 is an exemplary block diagram of a wireless communication device according to one embodiment;

FIG. 3 is an exemplary flowchart illustrating the operation of the wireless communication device according to one embodiment;

FIG. 4 is an exemplary flowchart illustrating the operation of the wireless communication device according to another embodiment;

FIG. 5 is an exemplary flowchart illustrating the operation of a cell on the system according to one embodiment;

FIG. 6 is an exemplary signal flow diagram of signals between a system and a terminal operating on a current cell according to one embodiment; and

FIG. 7 is an exemplary signal flow diagram of signals between a system and a terminal according to another related embodiment.

### DETAILED DESCRIPTION

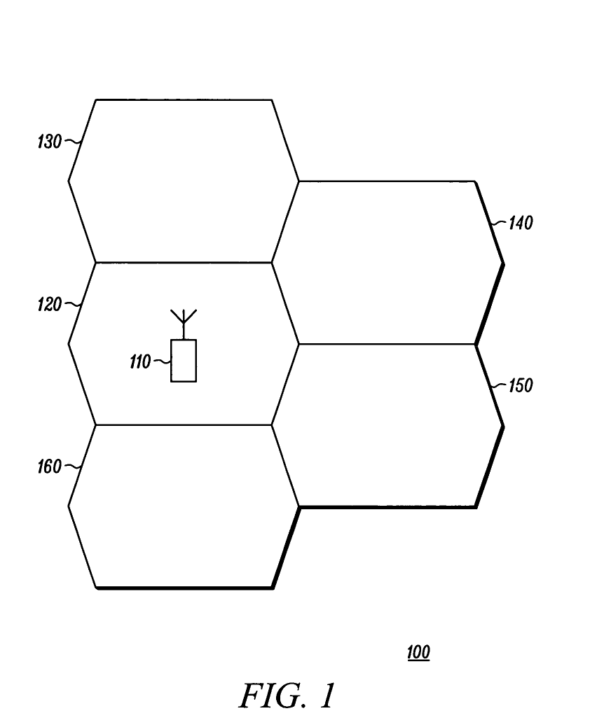

FIG. 1 is an exemplary block diagram of a system 100 according to one embodiment. The system 100 can include at least one terminal 110, a current cell 120, and other cells 130, 140, 150, and 160. The terminal 110 may include a telephone, a wireless telephone, a cellular telephone, a personal digital assistant, a pager, a personal computer, a mobile communication device, a selective call receiver, or any other device that is capable of sending and receiving communication signals on a network including wireless network. The system 100 may include any type of network that is capable of sending and receiving signals, such as wireless signals. For example, the system 100 may include a wireless telecommunications network, a cellular telephone network, a satellite communications network, and other like communications systems. Furthermore, the system 100 may include more than one network and may include a plurality of different types of networks. Thus, the system 100 may include a plurality of data networks, a plurality of telecommunications networks, a combination of data and telecommunications networks and other like communication systems capable of sending and receiving communication signals.

The cells may be divided into different sectors. For example, a cell may include a plurality of sectors. The cells may be any combination of global system for mobile communication (GSM) cells, code division multiple access (CDMA) cells, general packet radio service (GPRS) cells, time division multiple access (TDMA) cells, or any other type of cells. For example, all of the cells may be on the same network or different combinations of cells may be on different networks.

In operation, the terminal 110 can operate on a current cell 120. The terminal 110 or the current cell 120 may take measurements or consider data rate characteristics to determine whether to switch the terminal 110 to a neighbor cell 130. For example, the signal strength and/or the potential data rate of a neighbor cell 130 can be used to determine whether the terminal 110 should be switched to the cell 130 and/or to determine to which cell the terminal 110 should be switched. This determination can be based on which cell can support the best data rate for sending and receiving data to and from the terminal 110.

For example, a sector in a cell 130 or every sector in a cell 130, at periodic basis, can compute an average data rate, power head room, a spreading factor, and/or other useful information and report the results to the cell 130. The sector may also determine physical characteristics, such as spreading factor, coding rate, or the like which can eventually account for the data rate, and report the characteristics to the cell 130. The system 100, a controller on the system 100, or the cell 120 can send this information to the terminal 110 on periodic basis, when a threshold related to each or any of the measurements is crossed, or at any other useful time. According to the 3GPP2 standard, for example, a network can send a new Neighbor List Update Message to the terminal 110 on a Traffic Channel. The network could send this update periodically, or when the average performance of a neighbor cell 130 has changed by a predetermined amount. The terminal 110 can generate a prioritized active list, such as a list of candidate handoff cells, that is prioritized based on the information, such as the potential data rate of the candidate cells, to be sent to the current cell 120.

As part of generating the active list, the terminal 110 can use the information of a cell's expected data connection capability in the neighbor list. For example, the terminal 110 can use the combination of Pilot Strength measurements and an expected data rate, power head room, spreading factor, and/or the like in a candidate cell 130 to generate the active list. The terminal 110 can prioritize and/or order the cells in the list according to better data rate support and based on a pilot strength being above a threshold value that allows the cell 130 to be added to the list. Thus, the terminal 110 can generate a prioritized list at least partially based on the potential data rate of candidate cells. The terminal 110 can then send an enhanced or prioritized active list to the network the terminal 110 is currently operating on in the cell 120. The network can then use the prioritized active list to perform a soft or hard handoff. The terminal 110 can take measurements of the neighbor cells and generate a target cell which supports best data rate and can perform an IDLE handoff procedure. Using a prioritized list can help the terminal 110 get handed off to a cell that supports a better data rate. Using a prioritized list may also be useful when handing off a terminal between different technologies, such as CDMA-1X, GSM/general packet radio system (GPRS), wireless local area network (WLAN), or the like.

According to a related embodiment, a current data rate of the current cell 120 can be compared with an expected data rate of neighboring cells. Neighboring cells or systems that exceed a predetermined signal quality threshold and also exceed the current cell's data rate by a sufficient amount can trigger the terminal 110 to request a handoff. For example, if the terminal 110 is capable of monitoring CDMA-1X and WCDMA systems that overlap, the terminal 110 may be getting 50 kbps on CDMA-1X and can receive information from the system 100 that the WCDMA network is capable of delivering 200 kbps. The terminal 110 can then search for a WCDMA network. If the terminal 110 finds the network matching the one specified by the system 100, it can send a message to the system 100 indicating it has detected the new network and requesting a handoff to the network capable of higher throughput. Thus, the terminal 110 can generate a prioritized active list based not only on signal strength measurements, but also based on the potential data rates of neighboring cells. The prioritization can be based on an allowable signal strength band, which can be mapped to a supported data rate. Weights can be statistically assigned to signal strength measurements where a high signal strength can be given more weight and the weight can decrease as the signal strength decreases.

The system 100 can provide an accurate estimation of the time it may take to download data. The system 100 can further provide for an application to be generated to guide the terminal 110 to a better quality cell. For example, the application can guide the terminal 110 to the nearest better cell or to a hotspot. The system 100 can further provide for an accurate estimation of the time it may take to download data to the terminal 110. Thus, the terminal 110 can assist a network in handing the terminal 110 off to a cell that supports a better data rate than other neighboring cells or a better data rate than the current cell 120.

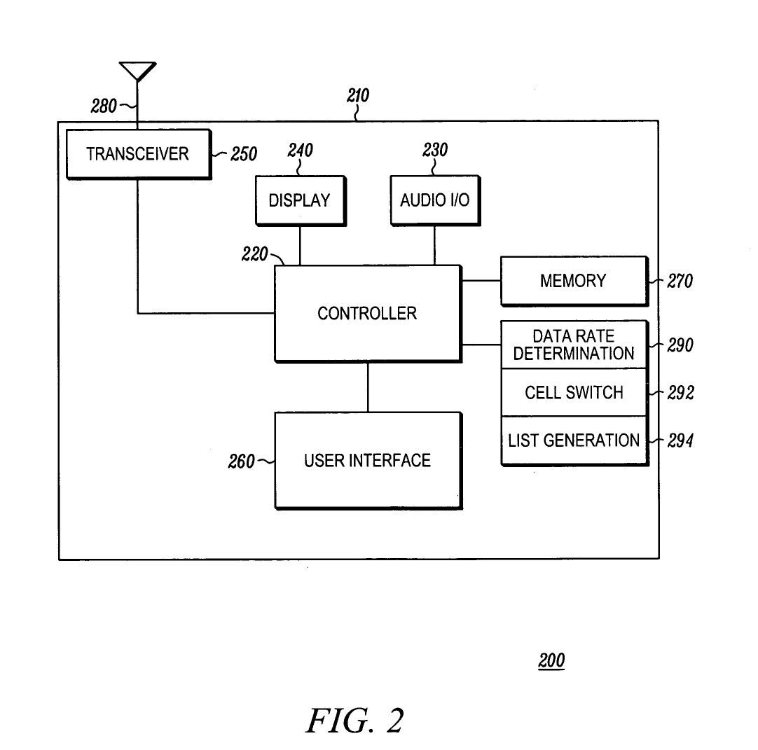

FIG. 2 is an exemplary block diagram of a wireless communication device 200, such as the terminal 110, according to one embodiment. The wireless communication device 200 can include a housing 210, a controller 220 coupled to the housing 210, audio input and output circuitry 230 coupled to the housing 210, a display 240 coupled to the housing 210, a transceiver 250 coupled to the housing 210, a user interface 260 coupled to the housing 210, a memory 270 coupled to the housing 210, and an antenna 280 coupled to the housing 210 and the transceiver 250. The wireless communication device 200 can also include a data rate determination module 290 and a cell switch module 292. The wireless communication device 200 can also include a list generation module 294. The data rate determination module 290, the cell switch module 292, and/or the list generation module 294 can be coupled to the controller 220, can reside within the controller 220, can reside within the memory 270, can be autonomous modules, can be software, can be hardware, or can be in any other format useful for a module on a wireless communication device 200.

The display 240 can be a liquid crystal display (LCD), a light emitting diode (LED) display, a plasma display, or any other means for displaying information. The transceiver 250 may include a transmitter and/or a receiver. The audio input and output circuitry 230 can include a microphone, a speaker, a transducer, or any other audio input and output circuitry. The user interface 260 can include a keypad, buttons, a touch pad, a joystick, an additional display, or any other device useful for providing an interface between a user and an electronic device. The memory 270 may include a random access memory, a read only memory, an optical memory, a subscriber identity module memory, or any other memory that can be coupled to a mobile communication device.

In operation, the transceiver 250 can operate the wireless communication device 200 on a first cell, such as cell 120. The data rate determination module 290 can determine an expected data rate of a second cell, such as cell 130. The list generation module 294 can generate a list of potential destination cells, such as cells 130, 140, 150 and 160, based on pilot strength measurements and based on the expected data rate of the potential destination cells. The list may also be based on statistically weighting signal strength information and expected data rate information to obtain an optimal cell, such as cell 130, which supports a high data rate compared to other cells in the list of potential destination cells. The transceiver 250 can transmit the list of potential destination cells to the current cell 120. The current cell 120 can send a message to the wireless communication device 200 to switch cells. The cell switch module 292 can switch from the first cell 120 to the second cell 130 based on the expected data rate.

The controller 220 can further be configured to perform measurements on a periodic basis, and determine a best supported cell. The controller 220 can additionally be configured to perform an idle handoff procedure when a serving cell 120 expected data rate decreases a predetermined amount. The controller 220 can also be configured to estimate a data download time based on the expected data rate. The controller 220 can further be configured to receive directions to a cell 130 with a better data rate than a current cell 120 based on a location direction procedure, a global positioning system, or any other useful system or procedure.

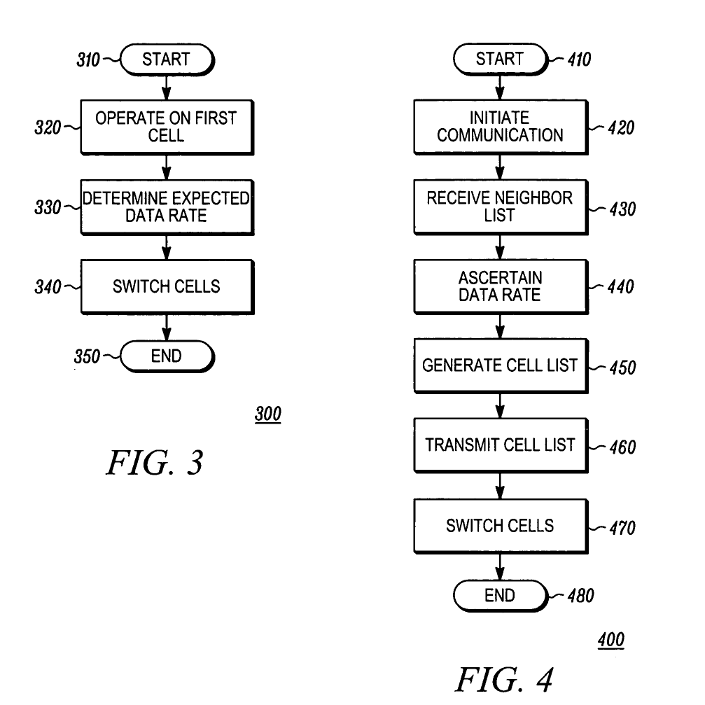

FIG. 3 is an exemplary flowchart 300 illustrating the operation of the wireless communication device 200 according to one embodiment. In step 310, the flowchart begins. In step 320, the wireless communication device 200 can operate on a first cell. In step 330, the wireless communication device 200 can determine an expected data rate of a second cell. In step 340, the wireless communication device 200 can switch from the first cell to the second cell based on the expected data rate. Switching from the first cell to the second cell further can, but does not necessarily include releasing a link layer connection with a base station on the first cell, disconnecting a physical channel on the first cell, switching to a new assigned channel on the second cell, and initiating the establishment of lower layer connections on the second cell. In step 350, the flowchart 300 can end.

FIG. 4 is an exemplary flowchart 400 illustrating the operation of the wireless communication device 200 according to another embodiment. The steps of flowchart 400 may be combined with flowchart 300, but it is not necessary to do so. In step 410, the flowchart begins. In step 420, the wireless communication device 200 can initiate an ongoing packet data communication or it can be in an IDLE state. In step 430, the wireless communication device 200 can receive a neighbor list. The neighbor list can include data rate information of the second cell and the wireless communication device 110 can perform measurements and determine signal strength information of the second cell. In step 440, the wireless communication device 200 can ascertain the expected data rate of the second cell exceeds the current data rate of the first cell. In step 450, the wireless communication device 200 can generate list of potential destination cells. For example, the list can be a prioritized list based on the neighbor list and based on a weighted data rate and a weighted signal strength. The potential destination cells may include the second cell. The list may also be based on pilot strength measurements and based on the expected data rate of the potential destination cells. The wireless communication device 200 may also generate a prioritized list by statistically weighting the signal strength information and the data rate information to obtain an optimal cell that supports a high data rate compared to other cells in the neighbor list. The wireless communication device 200 can also generate a prioritized list by statistically weighting the signal strength information and the data rate information and then order the neighbor list based on the statistically weighted signal strength information and the data rate information.

In step 460, the wireless communication device 200 can transmit the list of potential destination cells. In step 470, the wireless communication device 200 can receive a handoff command instructing the device to handoff to the second cell. In step 480, the wireless communication device 200 can switch from the first cell to the second cell while in the ongoing packet data communication. In step 480, the flowchart 400 can end.

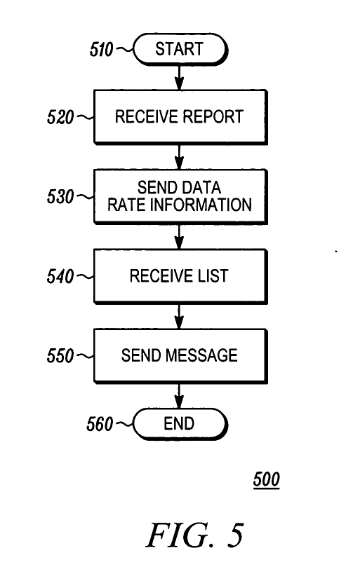

FIG. 5 is an exemplary flowchart 500 illustrating the operation of a cell, such as the cell 120, on the system 100 according to one embodiment. In step 510, the flowchart begins. In step 520, the cell 120 can receive a report including data rate information, power head room, spreading factor, and/or other useful information from each of the sectors of the cell. The report can be received on a periodic basis. For example, the cell 120 can continuously receive reports including data rate information. In step 530, the cell 120 can send the data rate information to a communication device, such as the terminal 110. As an example, the cell 120 can send the data rate information when information regarding a neighboring cell exceeds a quality threshold. For example, the cell 120 can send the data rate information when the data rate of a neighboring cell exceeds a specified data rate. As an additional example, the cell 120 can send data rate information when a data rate of a neighboring cell exceeds a data rate of the current cell 120 by a predetermined amount. As a further example, the cell 120 can send a neighbor list including the data rate information and radio related attributes to the terminal 110 when an attribute in the network exceeds a threshold. The threshold can be based on the expected data rate of a neighbor cell exceeding a threshold, on a difference supported data rates between two cells exceeding thresholds, or on any other useful threshold. In step 540, the cell 120 can receive a list from the terminal 110, the list including at least one potential handoff cell, such as the cell 130. For example, the cell 120 can receive a list including a plurality of potential handoff cells ordered at least partially based on the data rate information. The list can also be ordered at least partially based on signal strength information. In step 550, the cell 120 can send a message indicating a handoff of the terminal 110 to the potential handoff cell. For example, the cell 120 can send the message indicating a handoff of the terminal 120 to a potential handoff cell based on the order of the potential handoff cells. As another example, the cell 120 can send a message to indicate a handoff of the terminal 110 to the potential handoff cell on a periodic basis. A neighbor list can be pushed to the terminal 110 when any of the thresholds in the cell exceed a predetermined amount. A neighbor cell can be one of a cell on a same system as the current cell and a cell on a different system as the current cell. In step 560, the flowchart 500 ends.

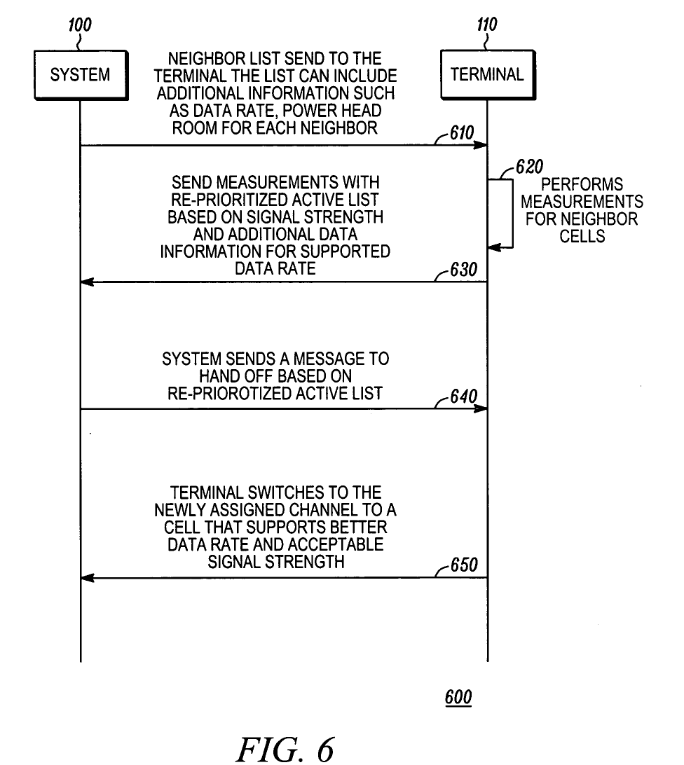

FIG. 6 is an exemplary signal flow diagram 600 of signals between the system 100 and a terminal 110 operating on a current cell 120 according to one embodiment. In step 610, the system 100 can send a neighbor list to the terminal 110. The list can include a list of neighbor cells along with additional information, such as the data rate, the power headroom, and the like for each neighbor cell. In step 620, the terminal 110 can perform measurements of characteristics, such as the signal strength or the like, of the neighbor cells on the list. In step 630, the terminal 110 can send the measurements on a reprioritized list prioritized based on, for example, signal strength, data information, and other information to the system 100. In step 640, the system 100 can send a message to the terminal 110 to handoff to a cell, such as cell 130, different from the current cell 120, based on information in the reprioritized list. In step 650, the terminal 110 can switch to a newly assigned channel on a cell 130 that has an acceptable signal strength and supports a better data rate than the other cells 140, 150, and 160 and/or the current cell 120.

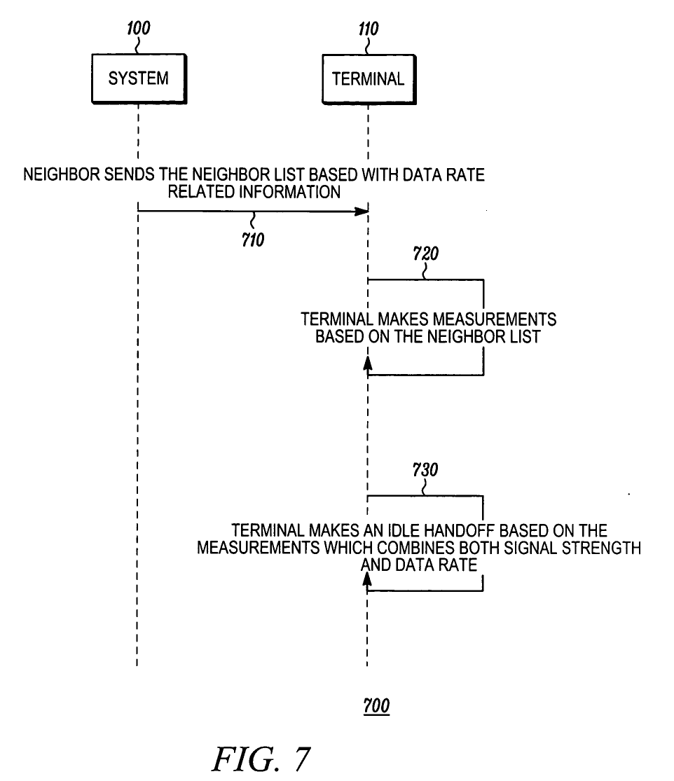

FIG. 7 is an exemplary signal flow diagram 700 of signals between a system 100 and a terminal 110 according to another related embodiment. In step 710, the system 100 can send a neighbor list that includes data rate information to the terminal 110. In step 720, the terminal 110 can take measurements based on the neighbor list. In step 730, the terminal 110 can make an idle handoff based on measurements that can include both the signal strength measurements and data rate information.

The method of this disclosure is preferably implemented on a programmed processor. However, the controllers, flowcharts, and modules may also be implemented on a general purpose or special purpose computer, a programmed microprocessor or microcontroller and peripheral integrated circuit elements, an ASIC or other integrated circuit, a hardware electronic or logic circuit such as a discrete element circuit, a programmable logic device such as a PLD, PLA, FPGA or PAL, or the like. In general, any device on which resides a finite state machine capable of implementing the flowcharts shown in the Figures may be used to implement the processor functions of this disclosure.

While this disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, the preferred embodiments of the disclosure as set forth herein are intended to be illustrative, not limiting. Various changes may be made without departing from the spirit and scope of the disclosure.

What is claimed is:

1. A method in a wireless communication device comprising:
operating the wireless communication device on a first cell;
determining an expected data rate of a second cell; and
switching from the first cell to the second cell based on the expected data rate.

2. The method according to claim 1, further comprising:
generating a list of potential destination cells, the potential destination cells including the second cell, based on pilot strength measurements and based on the expected data rate of the potential destination cells; and
transmitting the list of potential destination cells.

3. The method according to claim 1, further comprising:
initiating an ongoing packet data communication; and
ascertaining the expected data rate of the second cell exceeds the current data rate of the first cell;
wherein switching further comprises switching from the first cell to the second cell while in the ongoing packet data communication.

4. The method according to claim 1, wherein the first cell and the second cell comprise one of a global system for mobile communication cell, a code division multiple access cell, a general packet radio service cell and a wireless local area network cell.

5. The method according to claim 1, wherein the device comprises a selective call receiver.

6. The method according to claim 1, further comprising:
receiving a neighbor list, the neighbor list including data rate information of the second cell, power head room information, and spreading factor information of the second cell; and
generating a prioritized list from the neighbor list based on a weighted data rate and a weighted signal strength.

7. The method according to claim 6, wherein generating a prioritized list further comprises statistically weighting the signal strength information and the data rate information to obtain an optimal cell that supports a high data rate compared to other cells in the neighbor list.

8. The method according to claim 6, wherein generating a prioritized list further comprises statistically weighting the signal strength information and the data rate information,
wherein the method further comprises ordering the neighbor list based on the statistically weighted signal strength information and the data rate information.

9. The method according to claim 1, further comprising receiving a handoff command instructing the device to handoff to the second cell.

10. The method according to claim 1, wherein switching from the first cell to the second cell further comprises:
releasing a link layer connection with a base station on the first cell;
disconnecting a physical channel on the first cell;
switching to a new assigned channel on the second cell; and
initiating the establishment of lower layer connections on the second cell.

11. A method in a wireless communication network comprising:
receiving a report including data rate information;
sending the data rate information to a communication device;
receiving a list including at least one potential handoff cell, the list based on the data rate information and signal strength information; and
sending a message indicating a handoff of the communication device to the potential handoff cell.

12. The method according to claim 11,
wherein receiving a list further comprises receiving a list including a plurality of potential handoff cells ordered at least partially based on the data rate information, and
wherein sending the message further comprises sending the message indicating a handoff of the communication device to a potential handoff cell based on the order of the potential handoff cells.

13. The method according to claim 11, wherein receiving a report further comprises continuously receiving reports including data rate information.

14. The method according to claim 11, wherein receiving a report further comprises periodically receiving the report.

15. The method according to claim 11, wherein sending the data rate information further comprises sending the data rate information when information regarding a neighboring cell exceeds a quality threshold.

16. The method according to claim 11, wherein sending the data rate information further comprises sending the data rate information when a data rate of a neighboring cell exceeds a data rate of a current cell on which the communication device is operating by a predetermined amount.

17. The method according to claim 16, wherein a neighbor cell comprises one of a cell on a same system as the current cell and a cell on a different system as the current cell.

18. The method according to claim 11, wherein sending the data rate information further comprises sending a neighbor list including the data rate information and radio related attributes to the communication device when an attribute in the network exceeds a threshold.

19. The method according to claim 18,
wherein the threshold is based on one of the expected data rate of a neighbor cell exceeding a threshold and a difference in supported data rates between two cells exceeding a threshold, and
wherein the threshold is configurable.

20. A wireless communication device comprising:
a transceiver configured to operate the wireless communication device on a first cell; and
a controller coupled to the transceiver, the controller including
a data rate determination module configured to determine an expected data rate of a second cell; and
a cell switch module configured to switch from the first cell to the second cell based on the expected data rate.

21. The wireless communication device according to claim 20,
wherein the controller further includes a list generation module configured to generate a list of potential destination cells, the potential destination cells including the second cell, based on pilot strength measurements and based on the expected data rate of the potential destination cells, and
wherein the transceiver is further configured to transmit the list of potential destination cells.

22. The wireless communication device according to claim 20, wherein the controller further includes a list generation module configured to generate a list of potential destination cells, the potential destination cells including the second cell, the list including information based on statistically weighting signal strength information and expected data rate information to obtain an optimal cell that supports a high data rate compared to other cells in the list of potential destination cells.

23. The wireless communication device according to claim 20, wherein the controller is configured to perform measurements on a periodic basis, and determine a best supported cell,
wherein the controller is further configured to perform an idle handoff procedure when a serving cell expected data rate decreases a predetermined amount.

24. The wireless communication device according to claim 20, wherein the controller is further configured to estimate a data download time based on the expected data rate.

25. The wireless communication device according to claim 20, wherein the controller is configured to receive directions to a cell with a better data rate than a current cell based on one of a location direction procedure and a global positioning system.
